(19) United States
(12) Patent Application Publication
(10) Pub. No.: US 2005/0213305 A1
(43) Pub. Date: Sep. 29, 2005

(54) Integrated internal power supply

(75) Inventors: Michael Martin, Sykesville, MD (US); Bryan E. Dubois, New Market, MD (US); Kenneth Maurer, Mount Airy, MD (US)

Correspondence Address: ALUN L. PALMER, PATENT AGENT, 4300 PINEY CHURCH ROAD, WALDORF, MD, 20602, US

(73) Assignee: Patton Electronics, Co., Gaithersburg, MD (US)

(21) Appl. No.: 10/807,183

(22) Filed: Mar. 24, 2004

(51) Int. Cl. H02H 1/00

(52) U.S. Cl. 361/714

(57) ABSTRACT

Integrated internal power supply with a power inlet connector arranged to protrude through a housing of an end-use equipment, and having internal circuitry potted in a thermally conducting material. A vent path is provided so that a component such as a large capacity electrolytic capacitor can vent surplus fluid, e.g. electrolyte and/or gas. The power supply has a standardized ‘footprint’ and may be mounted directly onto a circuit board in the end-use equipment. The supply is preferably assembled by mounting a board holder on an internal circuit board, mounting a clip on the power inlet connector, mounting the internal circuit board in a case, plugging a vent hole in the internal circuit board, filling the case with potting compound, baking the power supply, preferably at 100° C. for 10 minutes, and then unplugging the vent hole.

### BACKGROUND OF THE INVENTION

1. Field of the Invention

The invention relates to an integrated internal power supply. More particularly, the invention relates to a power supply having a vent for exhausting gasses or electrolyte from a capacitor, and a method of manufacture therefor.

2. Discussion of the Background

Familiar external wall-mount and table-top power supplies bear several characteristics that make them valuable and attractive. They are designed, marked and “listed” in compliance with accepted safety standards (typically IEC950/UL60950/EN60950 for IT communication equipment). The output voltages of such external power supplies are normally “Safety Extra Low Voltage” (SFLV), thus isolating the end-use equipment from hazardous voltages. External power supplies are self-contained, having a power inlet that is integral to the external power supply. They are also integral, having power inlet, fusing, noise suppression and all power conversion circuitry within the external package, and are fully insulated against electric shock and energy hazards. An external power supply is subject to environmental conditions no more severe than that to which the end-use equipment is subject. For example, if the end-use equipment operates across a 0-50 deg C. commercial range, the external power supply would be subject to the same range, not higher.

The designer of the end-use equipment can therefore limit his involvement in power supply design to the selection of an external power supply. He can choose from a range of output voltages and power ratings. In limiting his involvement to the selection of the specific external power supply, the designer does not have to have the expertise or spend the time to design power entry, wiring, fusing, noise suppression, shielding, insulation or mechanical packaging to complete a power supply design. The use of a “safety listed” external power supply is known to accelerate the safety testing of end-use equipment and to reduce the cost thereof, compared to the use of a power supply built within the end-use equipment.

However, external power supplies have some deficiencies. End-users do not like the appearance of the external supply as compared to the trim appearance of end-use equipment with an integral power supply. End-users also do not like the consumption of floor-space or wall-outlet space consumed by an external power supply, compared to the simple power cord of end-use equipment having an integral power supply. They also tend to question the quality of an external power supply and question the effectiveness of the vendor quality control exercised by the end-use equipment manufacturer over the external power supply manufacturer. The external power supply appears to be a generic commodity for which the manufacturer will take only nominal responsibility. This is in contrast to a power supply which is integral within end-use equipment, for which it is widely expected the manufacturer will take full responsibility.

The long output cable and the output connector of the external power supply degrades the quality of power delivered to the end-use equipment This degradation is particularly significant when delivering low voltages (for example, 5V, 3.3V) directly to sensitive electronic circuitry. The long cable and connector introduce greater voltage drop, higher impedance and longer response time. The end-use equipment designer must often add components to restore the low-impedance characteristic of the power source and to mitigate the longer response time. In cases of severe voltage drop, a power supply with remote voltage sense adjustment capability must be used. The long output cable also presents a path out of the end-use equipment for conducted electromagnetic interference (EMI). End-use equipment designers must often add noise suppression components to mitigate this problem.

### SUMMARY

This invention provides an integrated, internal power supply. The power supply is integrated in that it includes in one mechanical construction the power inlet connector, the noise suppression, safety limiting, isolation and power conversion components. It is internal in that it is designed to be incorporated in the interior of the end-use electronic equipment

The invention retains the valuable characteristics of the external power supply listed above while overcoming the deficiencies of the existing techniques. Firstly, the power supply is located within the end-use equipment enclosure. In a preferred embodiment, the power supply according to the invention presents a power inlet connector so that connector can protrude through the walls of the equipment enclosure. The power supply is, itself, fully enclosed and insulated against hazards such as electric shock or electric energy, and is designed in accordance with the safety standards suiting the end-use equipment. It can also be “listed” and marked according to those safety standards, and can bear “conditions of acceptability” that make it suitable for immediate employment within the end-use equipment with no further engineering needed in order to provide protection against hazards. The operating temperature range may be extended beyond the typical commercial range so that it can operate in the elevated temperatures within the end-use equipment. The power supply may also be encapsulated or ‘potted’ with a thermally conductive material for the purpose of conducting heat from the semiconductors and components within the power supply to the surface of the power supply. The inventors have found that natural convective airflow was inadequate to cool the semiconductors within an enclosed power supply that was fully within end-use equipment.

In a preferred embodiment of the invention, the power supply output feeds the point of load within inches, one from the other. Being integral within the end-use equipment, there is very little loss or voltage drop in distribution. The power supply system of the invention is modular in design. The inventive power supply presents a common mechanical interface where it mounts to a printed circuit board and where it presents it's inlet connector through the end-use equipment enclosure. The inlet connector, power outputs, indicator outputs, control inputs and the means of providing mechanical security are preferably arranged in a certain “footprint” which allow the use of alternate power supplies in a modular fashion. Power supplies with differing input voltage limits, inlet connectors, or output power ratings, for example, could be varied on a unit-to-unit basis in a manufacturing plant. One particular power supply may operate from 120-240 VAC using a standard, detachable power cord. Another may operate from 48 VDC provided on a terminal block connection. The footprint being the same, one end-use equipment printed circuit board and enclosure can accommodate either version of the invention.

By close integration of all the components from power inlet to power output, power density greater than that of an ordinary, non-integrated internal power supply may be obtained. Also by close integration of all the components, the inventive power supply can achieve a lower “cost per watt”, as compared to the labor-intensive cost of assembling an ordinary, non-integrated internal power supply.

In a preferred embodiment, the power supply of the invention can provide a vent path for gases or electrolyte emitting from a failing electrolytic capacitor. This vent path is preferably created beginning underneath the capacitor, proceeding through a hole in the printed circuit board, through an intentional void in the potting material to the underside of the power supply module. The enclosure of the power supply can also, for example, integrate legs or lifters that position it off the surface of the end-use equipment's printed circuit board, this providing the final path for the venting gases or electrolyte.

The inventive power supply preferably includes mechanical features in the interior of the power supply enclosure in the form of steps, notches or grooves that position the printed circuit board within the enclosure during the application and curing of the potting material. The power supply of the invention also preferably includes an aperture design around the inlet connector that encloses the body of the connector to such a degree that potting material will not leak out before it cures and is still in the liquid state.

In a preferred embodiment of the invention, electronic potting materials are made use of to provide heat conduction to the outer surface of the power supply enclosure. The electronic components are preferably positioned within an enclosure, into which potting material is poured so that it displaces the air between the electronic components and the enclosure. This potting material provides a heat conduction path that is many times superior to that of air conduction or air convection. Where necessary, heat transfer can be enhanced by the addition of fins or undulating features which increase the area of the enclosure surface. Heat transfer can be further enhanced by selection of an appropriate potting material that permits the elimination of the power supply enclosure material, or rather, that by itself forms the enclosure surface. Further benefits include cost reduction through elimination of enclosure and even labeling, which can be formed into the potting material.

Although the invention incorporates various known techniques, the invention is more than the sum of the parts. The invention is a new combination of modularity, integration, power conversion, safety engineering, heat management, electronic function and cost reduction steps that produce a value much more than the sum of the individual constituents.

The invention having provided the benefits of modularity and integration in the provision of power, the invention also provides a platform for supplemental functions. These functions can enhance the capability of the power supply function or they can provide to the end-use equipment additional functions not directly related to the power supply function, but that also benefits the end-use equipment on account of the same principles of modularity, integration and cost reduction. Examples of integrated functions that enhance the capability of the power supply function are a.) current sharing circuitry, b.) voltage adjustment circuitry, c) remote voltage sensing and adjusting circuitry, d) output diode OR'ing circuitry, e) a voltage measurement device, f) a power quality measurement device, g) a “shutdown” input, h) a “power fail” output, l) an overvoltage protection circuit, j) an undervoltage lockout circuit, k) a current limit circuit, l) a battery management device, m) an early-power fail detection device, n) a voltage reference output or p) multiple outputs. Examples of other additional functions are a) a real-time clock, b) an elapsed-hour clock, c) an embedded serial number device, d) a radio-frequency identification device, e) an Ethernet interface, f) an integral internet communication device, g) a data logger device, h) a temperature monitor, i) a microprocessor supervision, reset and watchdog device, j) a non-volatile memory device, k) a wireless communication device, l) a global positioning system device, m) an encryption security key device or n) an asset management identification device.

Furthermore, the user of the invention benefits by the reduction in complexity. The user can enjoy the function of the invention by following the few and simple requirements of the common footprint and mechanical interface as compared to the complexity of developing from scratch a non-integrated internal power supply.

### BRIEF DESCRIPTION OF THE DRAWINGS

FIG. 1 is an exploded view of a power supply according to a preferred embodiment of the invention.

FIG. 2 is an exploded end view of a power supply according to a preferred embodiment of the invention.

FIG. 3 is a view of the underside of a power supply according to a preferred embodiment of the invention.

FIG. 4 is an exploded side view of a power supply according to the invention.

FIG. 5 is a plan view of a power supply according, to the invention.

FIG. 6 is an end view of a power supply according to the invention showing the vent path.

FIG. 7 is an end view of a power supply according to the invention showing a groove for supporting a circuit board.

FIG. 8 is an end view of a power supply according to the invention showing an alternative embodiment of the groove according to FIG. 7.

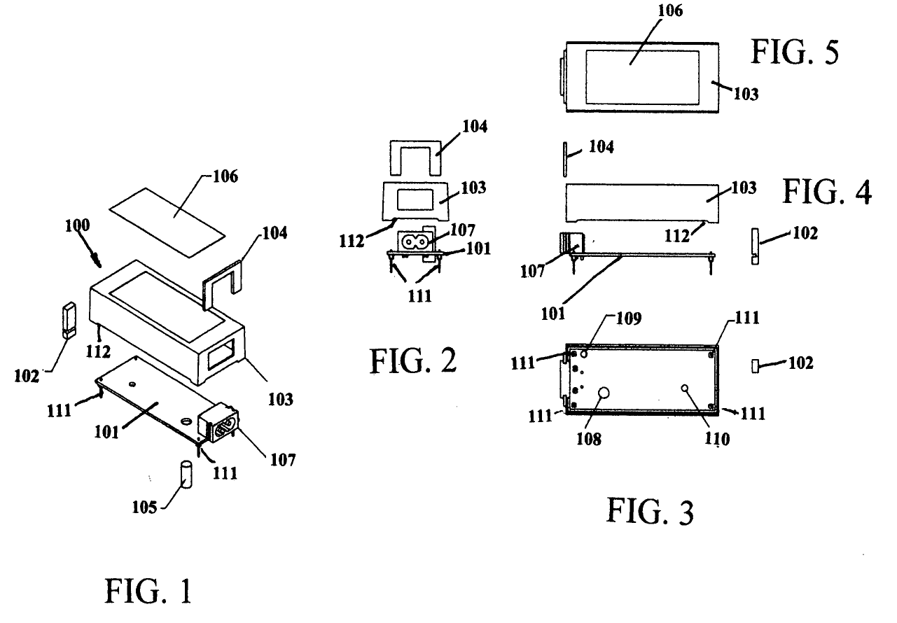

### DETAILED DESCRIPTION

In a preferred embodiment shown in the figures, an integrated internal power supply 100 according to the invention includes a printed circuit board 101 with an integral power connector 107 arranged so as to protrude through the wall of an equipment enclosure (not shown) when the power supply is mounted therein, as well as a board holder 102, a case 103 with a label 106, a clip 104, and a plug 105. Board 101 is also provided with a vent hole 108, potting fill holes 109 and 110, and pins 111. Vent hole 108 is provided to allow gasses and/or electrolyte to be vented from a capacitor employed in the power supply, such as a large electrolytic smoothing capacitor. Case 103 is preferably provided with steps or notches 112, to position the printed circuit board within the enclosure during the application and curing of the potting material. This ensures that the potting material covers the components.

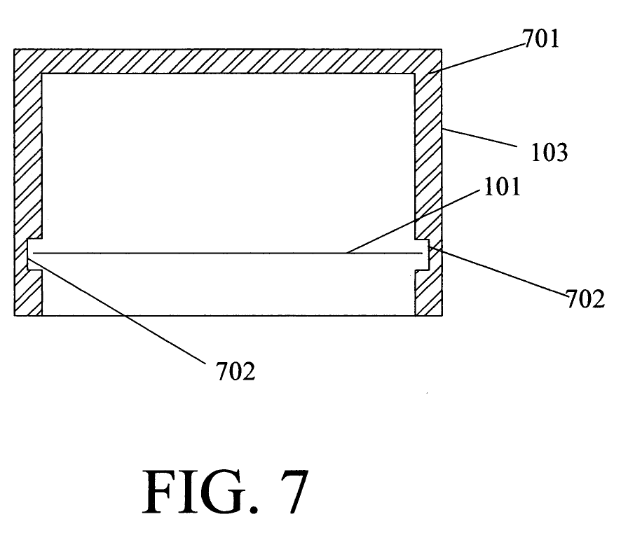

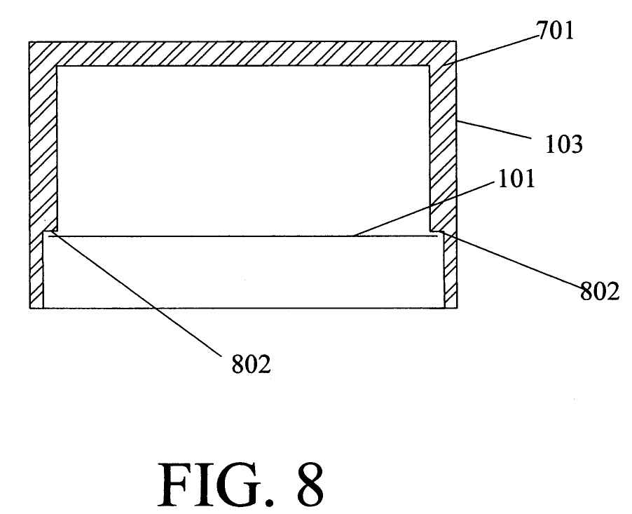

In another embodiment of the invention, as shown in FIG. 7, grooves 702 provided in the side walls 701 of the case 103 may be used to position the printed circuit board 101. FIG. 8 shows a further embodiment in which grooves 802 are provided in side walls 701 of case 103. Safety issues require that the board 101 be completely isolated, and notches 112 or grooves 702 or 802 formed in case 103 provide assurance that board 101 will not shift during assembly.

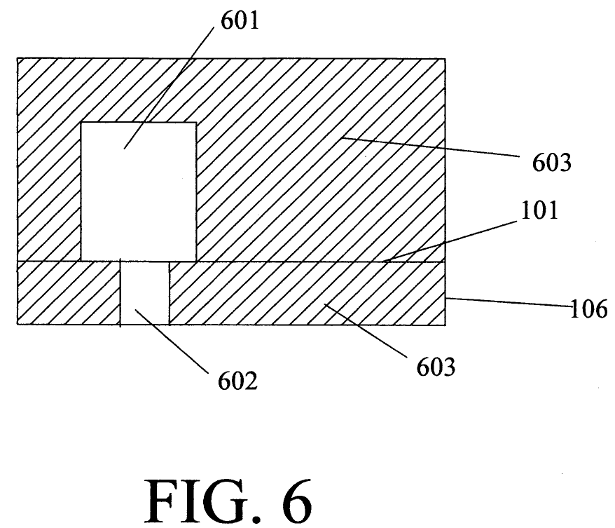

The plug 105 is used to prevent potting compound from filling the vent hole 108. Plug 105 is preferably a standoff as commonly used in electronics construction, but of course any other suitable means may be employed for this purpose, and may encompass, for example, a purpose made part, or any other suitable expedient. Plug 105 may be removed after the power supply is constructed, but it would be understood in the art that a hollow part could be employed that might be left in place. FIG. 6 is a cross-sectional view of the assembled power supply 100 in which the vent path is shown at 602. Vent 602 passes through vent hole 108 in internal circuit board 101, and allows any excess fluids such as gasses or electrolyte to escape from capacitor 601. The remainder of the interior of case 106 is filled with potting compound 603, both above and below internal circuit board 101.

The power supply according to the preferred embodiment of the invention is preferably assembled as follows. Board holder 102 is placed on printed circuit board 101. Then board 101 is placed in case 103 and clip 104 is slid into groove 112 in connector 107. The board 101 should now be secure. Next, standoff 105 is placed into capacitor vent hole 108 in board 101 to keep encapsulating material from flowing under the capacitor (not shown).

Next, a static mixing tube (not shown) is placed into one of the potting fill holes 109, 110 and the case 103 is filled with encapsulating or potting compound until it oozes up around the edges of the board 101. The mixing tube is then moved to the other one of the potting fill holes 109, 110 and filling is continued until the compound seeps up from the edges. This is repeated until no more potting compound can be injected without spilling over the edge of the case. Then, using the mixing tube, the top of the board 101 is flooded until the entire board 101 is covered evenly, taking care to keep the compound off pins 111. More compound is applied as needed, checking that the potting compound is level with the edge of the case 103, and that the components (not shown) on board 101 are completely immersed in potting compound. The potted unit is then placed in an oven and baked at about 100° C. for approximately 10 minutes. After the unit has cooled, standoff 105 can be removed from board 101 and label 106 may be affixed on case 103.

As will readily be appreciated by those skilled in the art, numerous modifications and variations of the above embodiments of the present invention are possible without departing from the scope of the invention.

1. A power supply, wherein:
said power supply is configured to be mounted inside an enclosure of an end-use equipment; and
said power supply comprises a power inlet connector configured to protrude through said equipment enclosure.

2. The power supply according to claim 1, wherein:
said end-use equipment comprises at least one end-use circuit board;
said power supply is configured to be mounted on said at least one end-use circuit board of said end-use equipment.

3. The power supply according to claim 1, comprising:
at least one internal circuit board, said internal circuit board having a first and a second surface; and
a case enclosing at least one of said first and second surfaces of said at least one internal circuit board; wherein:
a space between said at least one internal circuit board and said case is at least partially filled with a thermally conducting material.

4. The power supply according to claim 3, further comprising:
at least one component mounted on said at least one internal circuit board; and
a vent path through said at least one internal circuit board and through said thermally conducting material, whereby said at least one component is enabled to exhaust fluid therethrough.

5. A power supply, comprising:
a circuit board;
said circuit board comprising a vent hole; and
a case enclosing said circuit board;
said case filled with potting compound except for a vent path aligned with said vent hole.

6. The power supply according to claim 5, further comprising:
a board holder;
said board holder placed on said circuit board;
an electrical connector provided on said circuit board;
said connector comprising a groove therein; and
a clip formed in said groove.

7. The power supply according to claim 5, wherein:
said power supply is baked to cure said potting compound.

8. The power supply according to claim 7, wherein:
said power supply is baked at a temperature in the range from 80-120° C. for a period of 5-15 minutes.

9. The power supply according to claim 8, wherein:
said power supply is baked at 100° C. for 10 minutes.

10. The power supply according to claim 5, wherein:
said vent path is formed by blocking said potting compound from filling an area proximate said vent hole.

11. The power supply according to claim 5, wherein:
at least one locating groove in an interior surface of said case;
said circuit board located in said locating groove.

12. The power supply according to claim 5, wherein:
at least one notch in a lower edge of said case;
said circuit board located in said notch.

13. A method for assembling a power supply, comprising the steps of:
providing at least one internal circuit board;
said at least one internal circuit board comprising a vent hole;
providing a case;
placing said at least one internal circuit board in said case;
plugging said vent hole; and
filling said case with potting compound.

14. The method according to claim 13, further comprising the steps of:
providing a board holder,
placing said board holder on said circuit board;
providing a power inlet connector on said circuit board;
said power inlet connector comprising a groove therein
providing a clip; and
sliding said clip into said groove.

15. The method according to claim 13, further comprising the step of:
baking said power supply.

16. The method according to claim 15, wherein:
said power supply is baked at a temperature in the range from 80-120° C. for a period of 5-15 minutes.

17. The method according to claim 16, wherein:
said power supply is baked at 100° C. for 10 minutes.

18. The method according to claim 15, further comprising the step of:
after said power supply has cooled, unplugging said vent hole.

19. The method according to claim 13, further comprising the steps of:
after said step of filling said case with potting compound, unplugging said vent hole.

20. The method according to claim 13, further comprising the step of:
providing at least one locating groove in an interior surface of said case;
locating said circuit board in said locating groove.

21. The method according to claim 13, further comprising the step of:
providing at least one notch in a lower edge of said case;
locating said circuit board in said notch.
